(19) United States
(12) Patent Application Publication
(10) Pub. No.: US 2005/0139119 A1
(43) Pub. Date: Jun. 30, 2005

(54) Polishing composition

(76) Inventors: W. Scott Rader, Sherwood, OR (US); Jie Lin, Lake Oswego, OR (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/746,779

(22) Filed: Dec. 24, 2003

(51) Int. Cl. C09G 1/00

(52) U.S. Cl. 106/3

(57) ABSTRACT

A polishing composition of the present invention includes alumina, colloidal silica, citric acid, an organic acid other than citric acid, an oxidizing agent, and water. When the polishing composition is used in polishing the surface of a substrate for a magnetic disk, the substrate is polished at a high rate, and the substrate after polishing has reduced surface defects.

### BACKGROUND OF THE INVENTION

The present invention relates to a polishing composition used in polishing, for example, the surface of a substrate for a magnetic disk.

Substrates are usually subjected to a plurality of polishing stages during processing. In a first polishing stage, a polishing composition containing alumina, an organic acid, and water is generally used. For obtaining a substrate having reduced surface defects, it is desirable that the particle size of alumina contained in the polishing composition be as small as possible. However, the polishing composition containing alumina with a small particle size has little ability to polish a substrate at a high rate.

### SUMMARY OF THE INVENTION

The objective of the present invention is to provide a polishing composition capable of polishing an object at a high rate even if the particle size of alumina is small and capable of reducing surface defects of the object after polishing.

To achieve the above objective, the present invention provides a polishing composition, which includes alumina, colloidal silica, citric acid, an organic acid other than citric acid, an oxidizing agent, and water.

The present invention also provides a method of polishing a substrate for a magnetic disk. The method includes preparing a polishing composition, which includes alumina, colloidal silica, citric acid, an organic acid other than citric acid, an oxidizing agent, and water; and polishing a surface of the substrate using the polishing composition.

Other aspects and advantages of the invention will become apparent from the following description, illustrating by way of example the principles of the invention.

### DETAILED DESCRIPTION OF THE PREFERRED EMBODIMENTS

An embodiment of the present invention will now be described.

A polishing composition according to the embodiment comprises alumina, colloidal silica, an organic acid, an oxidizing agent, and water.

The alumina is used as an abrasive for polishing an object. The average particle diameter of the alumina is preferably at least 0.1 μm, more preferably at least 0.2 μm, and is preferably no more than 1.2 μm, more preferably no more than 1.0 μm. Alumina having an average particle diameter of at least 0.1 μm has a high polishing ability, and alumina having an average particle diameter of at least 0.2 μm has a particularly high polishing ability. Large particles will cause high surface roughness and large scratches on the polished surface of the object to be polished.

The content of the alumina in the polishing composition is preferably at least 0.01 wt %, more preferably at least 0.1 wt %, most preferably at least 0.2 wt %, and is preferably no more than 8 wt %, more preferably no more than 7 wt %, most preferably no more than 5 wt %. When the content of the alumina is too low, the polishing ability of the polishing composition may be degraded. When the content of the alumina is too high, the viscosity of the polishing composition may be excessively increased. Excessive increase of the viscosity degrades the handleability of the polishing composition.

The above-mentioned colloidal silica, like the alumina, is used as an abrasive for polishing an object. The average particle diameter of the colloidal silica is preferably at least 10 nm, more preferably at least 15 nm, and is preferably no more than 200 nm, more preferably no more than 100 nm. Colloidal silica having an average particle diameter of less than 10 nm may cause pits on the polished surface of the object to be polished. Colloidal silica having an average particle diameter of at least 15 nm has a high polishing ability. Colloidal silica having an average particle diameter of no more than 200 nm is easily obtainable, and colloidal silica having an average particle diameter of no more than 100 nm has excellent stability.

The content of the colloidal silica in the polishing composition is preferably at least 0.2 wt %, more preferably at least 0.6 wt %, most preferably at least 1 wt %, and is preferably no more than 10 wt %, more preferably no more than 8 wt %, most preferably no more than 6 wt %. When the content of the colloidal silica is too low, the polishing ability of the polishing composition may be degraded. When the content of the colloidal silica is too high, the viscosity of the polishing composition may be excessively increased.

The colloidal silica may be mono-dispersed, and may contain associated particles having high aspect ratio.

The above-mentioned organic acid acts chemically on an object to accelerate polishing with abrasives. Specific examples of the organic acid include citric acid, succinic acid, iminodiacetic acid, itaconic acid, maleic acid, malic acid, malonic acid, crotonic acid, gluconic acid, glycolic acid, lactic acid, and mandelic acid.

The polishing composition contains citric acid and an organic acid other than citric acid. The organic acid other than citric acid is preferably succinic acid, iminodiacetic acid, itaconic acid, maleic acid, malic acid, or malonic acid, and more preferably succinic acid. Succinic acid, iminodiacetic acid, itaconic acid, maleic acid, malic acid, and malonic acid have a high ability to accelerate polishing with abrasives, and succinic acid has a particularly high ability to accelerate polishing with abrasives.

The content of the citric acid in the polishing composition is preferably at least 0.02 wt %, more preferably at least 0.1 wt %, most preferably at least 0.2 wt %, and is preferably no more than 3 wt %, more preferably no more than 2 wt %, most preferably no more than 1.4 wt %. When the content of the citric acid is too low, the polishing ability of the polishing composition may be degraded. When the content of the citric acid is too high, it may be wasteful because the polishing ability of the polishing composition reaches a level of saturation, or the stability of colloidal silica in the polishing composition may be impaired.

The content of the organic acid other than citric acid in the polishing composition is preferably at least 0.002 wt %, more preferably at least 0.02 wt %, most preferably at least 0.1 wt %, and is preferably no more than 2 wt %, more preferably no more than 1 wt %, most preferably no more than 0.6 wt %. When the content of the organic acid other than citric acid is too low, the polishing ability of the polishing composition may be degraded. When the content of the organic acid other than citric acid is too high, it may be wasteful because the polishing ability of the polishing composition reaches a level of saturation, or the stability of colloidal silica in the polishing composition may be impaired.

The above-mentioned oxidizing agent oxidizes an object to accelerate polishing with abrasives. Specific examples of the oxidizing agent include hydrogen peroxide, iron nitrate, peroxodisulfuric acid, periodic acid, perchloric acid, and hypochlorous acid. The oxidizing agent is preferably hydrogen peroxide or periodic acid, and more preferably hydrogen peroxide. Hydrogen peroxide and periodic acid have a high ability to accelerate polishing with abrasives, and hydrogen peroxide has the benefit of ease of use.

The content of the oxidizing agent in the polishing composition is preferably at least 0.02 wt %, more preferably at least 0.2 wt %, most preferably at least 0.5 wt %, and is preferably no more than 2 wt %, more preferably no more than 1.7 wt %, most preferably no more than 1.5 wt %. When the content of the oxidizing agent is too low, the polishing ability of the polishing composition may be degraded. When the content of the oxidizing agent is too high, it may be wasteful because the polishing ability of the polishing composition reaches a level of saturation, the stability of the polishing composition may be impaired, or the handleability of the polishing composition may be degraded.

The above-mentioned water is used as a dispersing medium for dispersing the alumina and the colloidal silica, and is used as a solvent for dissolving the organic acid and the oxidizing agent. It is desirable that the content of impurities in the water be as low as possible. Preferably, the water is ion exchanged water, pure water, ultra-pure water or distilled water.

The polishing composition according to this embodiment is used in polishing, for example, the surface of a substrate for a magnetic disk. It is preferable that the polishing composition be used in the first polishing stage among a plurality of polishing stages that are generally carried out in the processing of a substrate.

By use of a polishing composition according to this embodiment in polishing an object, the object is polished at a high rate, and the object after polishing has reduced surface defects. The main reason for this is presumed to be that colloidal silica is electrostatically bonded onto the surface of each alumina particle in the polishing composition to relax the polishing force of the alumina appropriately. It is presumed that when an object is polished using the polishing composition, the alumina electrostatically bonded with colloidal silica polishes the surface of the object, which has been made brittle by the action of the organic acid and oxidizing agent.

It should be apparent to those skilled in the art that the present invention may be embodied in many other specific forms without departing from the spirit or scope of the invention. Particularly, it should be understood that the invention may be embodied in the following forms.

The polishing composition may contain two or more kinds of organic acids other than citric acid.

The polishing composition may contain known additives generally contained in a conventional polishing composition, for example, surfactants, chelating agents, preservatives, and the like.

The polishing composition may be stocked in the shape of two or more separate solutions. Each separate solution contains at least one component of the polishing composition.

The polishing composition may be prepared by dilution of an undiluted solution with water. The undiluted solution contains components other than water in the polishing composition at relatively high concentration. The content of alumina in the undiluted solution is preferably from 0.05 to 40 wt %, more preferably from 0.5 to 35 wt %, and most preferably from 1 to 25 wt %. The content of colloidal silica in the undiluted solution is preferably from 1 to 50 wt %, more preferably from 3 to 40 wt %, and most preferably from 5 to 30 wt %. The content of citric acid in the undiluted solution is preferably from 0.1 to 15 wt %, more preferably from 0.5 to 10 wt %, and most preferably from 1 to 7 w %. The content of an organic acid other than citric acid in the undiluted solution is preferably from 0.01 to 10 wt %, more preferably from 0.1 to 5 wt %, and most preferably from 0.5 to 3 wt %. The content of an oxidizing agent in the undiluted solution is preferably from 0.1 to 10 wt %, more preferably from 1 to 8.5 wt %, and most preferably from 2.5 to 7.5 wt %.

The polishing composition may be used in polishing an object other than a substrate for a magnetic disk. The polishing composition may be used in polishing, for example, metal such as nickel-iron alloy, ruthenium and platinum on an insulating substrate.

The present invention will be described more specifically by way of Examples and Comparative examples.

In Examples 1 to 22 and Comparative examples 1 to 21, undiluted polishing composition are prepared by mixing water with an abrasive and, as necessary, further mixing the mixture with an organic acid or inorganic acid and oxidizing agent. The details of the abrasive, organic acid or inorganic acid, and oxidizing agent used in each example are shown in Tables 1 to 3. The average particle diameter of alumina contained as an abrasive in each undiluted polishing composition is 0.6 μm in Examples 1 to 14 and Comparative examples 1 to 11 in Table 1, 0.8 μm in Examples 15 to 18 and Comparative examples 12 to 16 in Table 2, and 0.3 μm in Examples 19 to 22 and Comparative examples 17 to 21 in Table 3. The average particle diameter of colloidal silica contained as an abrasive in each undiluted polishing composition is 40 nm in every example. Polishing composition is prepared by five-fold dilution of each undiluted polishing composition with water, and is used in polishing an object under the following polishing conditions:
Polishing apparatus: Double side polishing machine “9.5B-5P” manufactured by System Seiko Co., Ltd.
Polishing pad: Polyurethane pad “CR200” manufactured by Kanebo, Ltd.
Object to be polished: Fifteen substrates each having a diameter of 3.5 inches obtained by performing electroless nickel phosphorus plating on the surface of a blank material made of aluminum alloy
Polishing load: 10 kPa
Rotational speed of upper platen: 24 rpm
Rotational speed of lower platen: 16 rpm
Feed rate of polishing composition: 150 ml/min
Polishing amount: A thickness of about 2 μm in total of both surfaces of each substrate

The polishing rates obtained when a substrate is polished using each polishing composition are shown in the column entitled “Rate” in Tables 1 to 3. Each of the polishing rates was obtained based on the following formula.

Formula
Rₚ=(W_{S1}−W_{S2})/(A_{S}·D_{S}·T_{P}·10⁻⁴)

In the formula, R_{P} represents the polishing rate [μm/min], W_{S1} represents weight [g] of a substrate before polishing, W_{S2} represents weight [g] of a substrate after polishing, As represents area [cm²] of the surface to be polished of a substrate, D_{S} represents density [g/cm³] of the substrate, and T_{P} represents the polishing time [min].

The conditions of the surface of a substrate polished using each polishing composition was evaluated by using a two-stage criterion of good [G] and not good [NG] according to the number of pits observed on the substrate surface. The evaluation results are shown in the column entitled “Pits” in Tables 1 to 3.

TABLES 1

| | | | Organic acid | | | | | |
|---|---|---|---|---|---|---|---|---|
| | Abrasive | | or inorganic acid | | Oxidizing agent | | Rate | |
| | (wt %) | | (wt %) | | (wt %) | | (μm/min) | Pits |
| Ex. 1 | Al₂O₃ | 15 | citric acid | 0.3 | hydrogen peroxide | 5 | 0.65 | G |
| | C—SiO₂ | 10 | succinic acid | 1 | 31% sol. | | | |
| Ex. 2 | Al₂O₃ | 15 | citric acid | 1.5 | hydrogen peroxide | 5 | 0.67 | G |
| | C—SiO₂ | 10 | succinic acid | 1 | 31% sol. | | | |
| Ex. 3 | Al₂O₃ | 15 | citric acid | 3 | hydrogen peroxide | 5 | 0.70 | G |
| | C—SiO₂ | 10 | succinic acid | 1 | 31% sol. | | | |
| Ex. 4 | Al₂O₃ | 15 | citric acid | 3 | hydrogen peroxide | 5 | 0.68 | G |
| | C—SiO₂ | 2 | succinic acid | 1 | 31% sol. | | | |
| Ex. 5 | Al₂O₃ | 15 | citric acid | 3 | hydrogen peroxide | 5 | 0.69 | G |
| | C—SiO₂ | 4 | succinic acid | 1 | 31% sol. | | | |
| Ex. 6 | Al₂O₃ | 15 | citric acid | 3 | hydrogen peroxide | 5 | 0.63 | G |
| | C—SiO₂ | 10 | succinic acid | 0.05 | 31% sol. | | | |
| Ex. 7 | Al₂O₃ | 15 | citric acid | 3 | hydrogen peroxide | 5 | 0.66 | G |
| | C—SiO₂ | 10 | succinic acid | 0.3 | 31% sol. | | | |
| Ex. 8 | Al₂O₃ | 15 | citric acid | 3 | hydrogen peroxide | 0.5 | 0.60 | G |
| | C—SiO₂ | 10 | succinic acid | 1 | 31% sol. | | | |
| Ex. 9 | Al₂O₃ | 15 | citric acid | 3 | hydrogen peroxide | 2 | 0.65 | G |
| | C—SiO₂ | 10 | succinic acid | 1 | 31% sol. | | | |
| Ex. 10 | Al₂O₃ | 15 | citric acid | 3 | hydrogen peroxide | 5 | 0.67 | G |
| | C—SiO₂ | 10 | iminodiacetic acid | 1 | 31% sol. | | | |
| Ex. 11 | Al₂O₃ | 15 | citric acid | 3 | hydrogen peroxide | 5 | 0.66 | G |
| | C—SiO₂ | 10 | itaconic acid | 1 | 31% sol. | | | |
| Ex. 12 | Al₂O₃ | 15 | citric acid | 3 | hydrogen peroxide | 5 | 0.60 | G |
| | C—SiO₂ | 10 | glycolic acid | 1 | 31% sol. | | | |
| Ex. 13 | Al₂O₃ | 15 | citric acid | 3 | iron nitrate | 5 | 0.60 | G |
| | C—SiO₂ | 10 | succinic acid | 1 | | | | |
| Ex. 14 | Al₂O₃ | 15 | citric acid | 3 | peroxodisulfuric | 5 | 0.59 | G |
| | C—SiO₂ | 10 | succinic acid | 1 | acid | | | |
| C. Ex. 1 | Al₂O₃ | 15 | succinic acid | 1 | hydrogen peroxide | 5 | 0.50 | G |
| | C—SiO₂ | 10 | | | 31% sol. | | | |
| C. Ex. 2 | Al₂O₃ | 15 | citric acid | 3 | hydrogen peroxide | 5 | 0.33 | NG |
| | | | succinic acid | 1 | 31% sol. | | | |
| C. Ex. 3 | Al₂O₃ | 15 | citric acid | 3 | hydrogen peroxide | 5 | 0.55 | G |
| | C—SiO₂ | 10 | | | 31% sol. | | | |
| C. Ex. 4 | Al₂O₃ | 15 | citric acid | 5 | hydrogen peroxide | 5 | 0.56 | G |
| | C—SiO₂ | 10 | | | 31% sol. | | | |
| C. Ex. 5 | Al₂O₃ | 15 | citric acid | 3 | — | — | 0.46 | G |
| | C—SiO₂ | 10 | succinic acid | 1 | | | | |
| C. Ex. 6 | Al₂O₃ | 15 | iminodiacetic acid | 3 | hydrogen peroxide | 5 | 0.53 | G |
| | C—SiO₂ | 10 | succinic acid | 1 | 31% sol. | | | |
| C. Ex. 7 | Al₂O₃ | 15 | itaconic acid | 3 | hydrogen peroxide | 5 | 0.50 | G |
| | C—SiO₂ | 10 | succinic acid | 1 | 31% sol. | | | |
| C. Ex. 8 | Al₂O₃ | 15 | glycolic acid | 3 | hydrogen peroxide | 5 | 0.46 | G |
| | C—SiO₂ | 10 | succinic acid | 1 | 31% sol. | | | |
| C. Ex. 9 | Al₂O₃ | 15 | aluminium nitrate | 3 | hydrogen peroxide | 5 | 0.47 | G |
| | C—SiO₂ | 10 | | | 31% sol. | | | |
| C. Ex. 10 | Al₂O₃ | 15 | aluminium nitrate | 3 | hydrogen peroxide | 5 | 0.51 | G |
| | C—SiO₂ | 10 | succinic acid | 1 | 31% sol. | | | |
| C. Ex. 11 | Al₂O₃ | 15 | iron nitrate | 3 | hydrogen peroxide | 5 | 0.35 | G |
| | C—SiO₂ | 10 | | | 31% sol. | | | |

TABLES 2

| | | | Organic acid | | | | | |
|---|---|---|---|---|---|---|---|---|
| | Abrasive | | or inorganic acid | | Oxidizing agent | | Rate | |
| | (wt %) | | (wt %) | | (wt %) | | (μm/min) | Pits |
| Ex. 15 | Al₂O₃ | 15 | citric acid | 3 | hydrogen peroxide | 5 | 0.91 | G |
| | C—SiO₂ | 10 | succinic acid | 1 | 31% sol. | | | |
| Ex. 16 | Al₂O₃ | 15 | citric acid | 3 | hydrogen peroxide | 5 | 0.87 | G |
| | C—SiO₂ | 10 | iminodiacetic acid | 1 | 31% sol. | | | |
| Ex. 17 | Al₂O₃ | 15 | citric acid | 3 | hydrogen peroxide | 5 | 0.85 | G |
| | C—SiO₂ | 10 | itaconic acid | 1 | 31% sol. | | | |
| Ex. 18 | Al₂O₃ | 15 | citric acid | 3 | hydrogen peroxide | 5 | 0.83 | G |
| | C—SiO₂ | 10 | glycolic acid | 1 | 31% sol. | | | |
| C. Ex. 12 | Al₂O₃ | 15 | succinic acid | 1 | hydrogen peroxide | 5 | 0.45 | NG |
| | C—SiO₂ | 10 | | | 31% sol. | | | |
| C. Ex. 13 | Al₂O₃ | 15 | citric acid | 3 | hydrogen peroxide | 5 | 0.48 | NG |
| | | | succinic acid | 1 | 31% sol. | | | |
| C. Ex. 14 | Al₂O₃ | 15 | citric acid | 3 | hydrogen peroxide | 5 | 0.75 | G |
| | C—SiO₂ | 10 | | | 31% sol. | | | |
| C. Ex. 15 | Al₂O₃ | 15 | citric acid | 3 | — | — | 0.70 | G |
| | C—SiO₂ | 10 | succinic acid | 1 | | | | |
| C. Ex. 16 | Al₂O₃ | 15 | iminodiacetic acid | 3 | hydrogen peroxide | 5 | 0.75 | G |
| | C—SiO₂ | 10 | succinic acid | 1 | 31% sol. | | | |

TABLES 3

| | | | Organic acid | | | | | |
|---|---|---|---|---|---|---|---|---|
| | Abrasive | | or inorganic acid | | Oxidizing agent | | Rate | |
| | (wt %) | | (wt %) | | (wt %) | | (μm/min) | Pits |
| Ex. 19 | Al₂O₃ | 15 | citric acid | 3 | hydrogen peroxide | 5 | 0.35 | G |
| | C—SiO₂ | 10 | succinic acid | 1 | 31% sol. | | | |
| Ex. 20 | Al₂O₃ | 15 | citric acid | 3 | hydrogen peroxide | 5 | 0.33 | G |
| | C—SiO₂ | 10 | iminodiacetic acid | 1 | 31% sol. | | | |
| Ex. 21 | Al₂O₃ | 15 | citric acid | 3 | hydrogen peroxide | 5 | 0.32 | G |
| | C—SiO₂ | 10 | itaconic acid | 1 | 31% sol. | | | |
| Ex. 22 | Al₂O₃ | 15 | citric acid | 3 | hydrogen peroxide | 5 | 0.31 | G |
| | C—SiO₂ | 10 | glycolic acid | 1 | 31% sol. | | | |
| C. Ex. 17 | Al₂O₃ | 15 | succinic acid | 1 | hydrogen peroxide | 5 | 0.23 | G |
| | C—SiO₂ | 10 | | | 31% sol. | | | |
| C. Ex. 18 | Al₂O₃ | 15 | citric acid | 3 | hydrogen peroxide | 5 | 0.10 | NG |
| | | | succinic acid | 1 | 31% sol. | | | |
| C. Ex. 19 | Al₂O₃ | 15 | citric acid | 3 | hydrogen peroxide | 5 | 0.20 | G |
| | C—SiO₂ | 10 | | | 31% sol. | | | |
| C. Ex. 20 | Al₂O₃ | 15 | citric acid | 3 | — | — | 0.18 | G |
| | C—SiO₂ | 10 | succinic acid | | | | | |
| C. Ex. 21 | Al₂O₃ | 15 | iminodiacetic acid | 3 | hydrogen peroxide | 5 | 0.25 | G |
| | C—SiO₂ | 10 | succinic acid | 1 | 31% sol. | | | |

As shown in Tables 1 to 3, the polishing rates obtained in Examples 1 to 14 are higher than the polishing rates obtained in Comparative examples 1 to 11, the polishing rates obtained in examples 15 to 18 are higher than the polishing rates obtained in Comparative examples 12 to 16, and the polishing rates obtained in Examples 19 to 22 are higher than the polishing rates obtained in Comparative examples 17 to 21. In Examples 1 to 22, the conditions of the surfaces of the polished substrates were excellent.

The present examples and embodiments are to be considered as illustrative and not restrictive and the invention is not to be limited to the details given herein, but may be modified within the scope and equivalence of the appended claims.

1. A polishing composition comprising alumina, colloidal silica, citric acid, an organic acid other than citric acid, an oxidizing agent, and water.

2. The polishing composition according to claim 1, wherein the polishing composition is used in polishing a surface of a substrate for a magnetic disk.

3. The polishing composition according to claim 1, wherein the alumina has an average particle diameter of from 0.2 to 1.0 μm.

4. The polishing composition according to claim 1, wherein content of the alumina in the polishing composition is from 0.2 to 5 wt %.

5. The polishing composition according to claim 1, wherein the colloidal silica has an average particle diameter of from 15 to 100 nm.

6. The polishing composition according to claim 1, wherein content of the colloidal silica in the polishing composition is from 1 to 3 wt %.

7. The polishing composition according to claim 1, wherein the organic acid other than citric acid is at least one organic acid selected from succinic acid, iminodiacetic acid, itaconic acid, maleic acid, malic acid, and malonic acid.

8. The polishing composition according to claim 7, wherein the organic acid other than citric acid is succinic acid.

9. The polishing composition according to claim 1, wherein content of the citric acid in the polishing composition is from 0.2 to 1.4 wt %.

10. The polishing composition according to claim 1, wherein content of the organic acid other than citric acid in the polishing composition is from 0.1 to 0.6 wt %.

11. The polishing composition according to claim 1, wherein the oxidizing agent is at least one oxidizing agent selected from hydrogen peroxide, iron nitrate, peroxodisulfuric acid, periodic acid, perchloric acid, and hypochlorous acid.

12. The polishing composition according to claim 11, wherein the oxidizing agent is hydrogen peroxide.

13. The polishing composition according to claim 1, wherein content of the oxidizing agent in the polishing composition is from 0.5 to 1.5 wt %.

14. The polishing composition according to claim 1, wherein an undiluted solution includes the alumina, the colloidal silica, the citric acid, the organic acid other than citric acid, the oxidizing agent, and part of the water, and the polishing composition is prepared by dilution of the undiluted solution with the remaining part of the water.

15. The polishing composition according to claim 14, wherein content of the alumina in the undiluted solution is from 1 to 25 wt %.

16. The polishing composition according to claim 14, wherein content of the colloidal silica in the undiluted solution is from 5 to 15 wt %.

17. The polishing composition according to claim 14, wherein content of the citric acid in the undiluted solution is from 1 to 7 wt %.

18. The polishing composition according to claim 14, wherein content of the organic acid other than citric acid in the undiluted solution is from 0.5 to 3 wt %.

19. The polishing composition according to claim 14, wherein content of the oxidizing agent in the undiluted solution is from 2.5 to 7.5 wt %.

20. A method of polishing a substrate for a magnetic disk, the method comprising:
preparing a polishing composition, wherein the polishing composition includes alumina, colloidal silica, citric acid, an organic acid other than citric acid, an oxidizing agent, and water; and
polishing a surface of the substrate using the polishing composition.
